(19) United States
(12) Patent Application Publication
(10) Pub. No.: US 2009/0150817 A1
(43) Pub. Date: Jun. 11, 2009

(54) Method and Apparatus Utilizing Profiles to Reduce Software Complexity

(75) Inventor: Robert J. Sisinni, Etobicoke (CA)

Correspondence Address: ADVANCED MICRO DEVICES, INC.;C/O VEDDER PRICE P.C., 222 N.LASALLE STREET, CHICAGO, IL, 60601, US

(73) Assignee: ATI Technologies ULC, Markham (CA)

(21) Appl. No.: 11/951,602

(22) Filed: Dec. 6, 2007

(51) Int. Cl. G06F 3/048

(52) U.S. Cl. 715/771

(57) ABSTRACT

Apparatus and methods relate to applications with references to profiles, wherein the profiles have parameter information that corresponds to device graphical user interface options. Profiles may be associated with hardware operations of the device, such as image, video, or audio en/decoding, and the parameter information corresponds to the capabilities and specifications of a hardware device. Corresponding systems for creating applications with at least one profile reference are also described.

### FIELD OF THE INVENTION

The disclosure generally relates to programming software and more particularly to reducing software complexity, such as multimedia software complexity.

### BACKGROUND OF THE INVENTION

Programming software applications is often complex. To further complicate matters, software applications are increasingly interacting with hardware devices, often performing multimedia operations. Hardware operations may include, for example, image capture and decode, video capture and playback, audio capture and playback, and overlay and display controls. For example, software may be used to capture media, with cameras or other recorders, such as images, video, and audio, and software may also be used to display media, on a display for example, such as images and video. Multimedia applications, however, are just one example of interactions between software and hardware devices. Software is often able to control various hardware devices, such as the multimedia devices mentioned above as well as other non-multimedia devices (e.g., modems, GPS units, input devices, storage devices, etc.

As more devices enter the market, designing software becomes more complex. This is, in part, because although two devices may perform the same hardware operation (e.g., capture video or audio), they may do it based on different parameters and capabilities. Thus, for example, the highest quality video capture capabilities on one camera may not be the same quality as the highest quality video capture capabilities on another camera. Software design can therefore be complex because the programmer must know all the parameters and capabilities for every piece of hardware with which the software may interact. This may take up hundreds of lines of code, and it therefore takes time to learn all of the configuration parameters for each piece of hardware. It also takes a great deal of time to program all of the configuration parameters. Furthermore, the completed software application is often very complex.

Therefore a need exists to create software applications that interact with hardware in a more efficient and less complex manner.

### BRIEF DESCRIPTION OF THE DRAWINGS

The invention will be more readily understood in view of the following description when accompanied by the below figures and wherein like reference numerals represent like elements, wherein:

FIG. 1 is a block diagram illustrating one example of a multimedia device in accordance with one embodiment of the invention;

FIG. 2 is one example of a graphical user interface viewable on a display in accordance with one embodiment of the invention;

FIG. 3 is a flowchart illustrating one example of a method for controlling hardware on a handheld device in accordance with one embodiment of the invention;

FIG. 4 is a flowchart illustrating one example of a method for controlling hardware on a handheld device in accordance with one embodiment of the invention;

FIG. 5 is a block diagram illustrating one example of a software development system in accordance with one embodiment of the invention; and

FIG. 6 is one example of a graphical user interface viewable on a display for generating an application in accordance with one embodiment of the invention.

### DETAILED DESCRIPTION OF THE PREFERRED EMBODIMENTS

Briefly, a device, such as a multimedia device, includes memory comprising profiles that contain parameter information, wherein the profiles correspond to device programmable options, which correspond to options presented through a graphical user interface. The device programmable options may include configuration settings for a device, such as hardware settings or software settings. The memory may comprise a set of profiles for a common device function. The device also contains processing circuitry operative to use the parameter information in response to executing stored computer readable instructions that reference the profiles. The parameter information may be associated with a hardware operation of the device, and may define, for example, a bit rate, a codec type, and a frame rate. Other examples of parameter information include, but are not limited to, encoding modes, frame size, and overlay position.

In one example, the processing circuitry may be operative to created a combined profile containing parameter information from at least one profile This combined profile may contain parameter information for at least two hardware devices, such as video hardware and audio hardware.

A method also exists for controlling hardware on a handheld device that includes activating an application containing at least one profile reference, wherein the profile reference references a profile that contains parameter information and corresponds to device graphical user interface options. This is not a one-to-one correspondence. As one good example, parameter information may correspond to the graphical user interface, but it may also correspond to an embedded device manufacturer's specifications for a given use case (even without a direct graphical user interface). The method also includes performing a hardware operation using parameter information from at least one profile associated with the at least one profile reference.

In another example, the method may include cling a profile combiner module and combining parameter information from more than one profile to build a combined profile that corresponds to device graphical user interface options or design decisions. Additionally, the method may include assigning the combined profile a new profile reference.

In another example, the method includes presenting, to a user, the device graphical interface options that correspond to the profile reference referencing the profile that contains parameter information and receiving user input. The method may also include receiving additional user input and passing at lest one additional profile reference, based on the additional use input, to am encoder to perform at least one additional hardware operation.

Additionally, a software development system includes a display, processing circuitry operative to execute computer readable instructions comprising an application generator to generate data, representing an application, from source code containing a profile reference that identifies a profile having parameter information that corresponds to device graphical user interface options, and memory containing the computer readable instructions and the application.

In another example, the application generator also provides an application generation user interface viewable on the display and operative to provide profile reference insertion options that correspond to a profile reference that identifies a profile having parameter information that corresponds to device graphical user interface options.

Among other advantages, the apparatus and methods allow a software developer to more easily and more efficiently develop applications, especially applications desired to be able to interface with a variety of hardware devices. For example, software developers do not need to learn long lists of parameters, a list that may be different for every device (even if the device performs the same function). Furthermore, even if the software developers were intimately familiar with all hardware devices with which they wished their applications to interact, the software developers must still program what may be hundreds of lines of code, which may take considerable time. The apparatus and methods disclosed herein may thus eliminate the need to spend time learning the intricacies of different pieces of hardware and save time that would otherwise be needed to program what often amounts to hundreds of lines of code. Other advantages will be recognized by one of ordinary skill in the art.

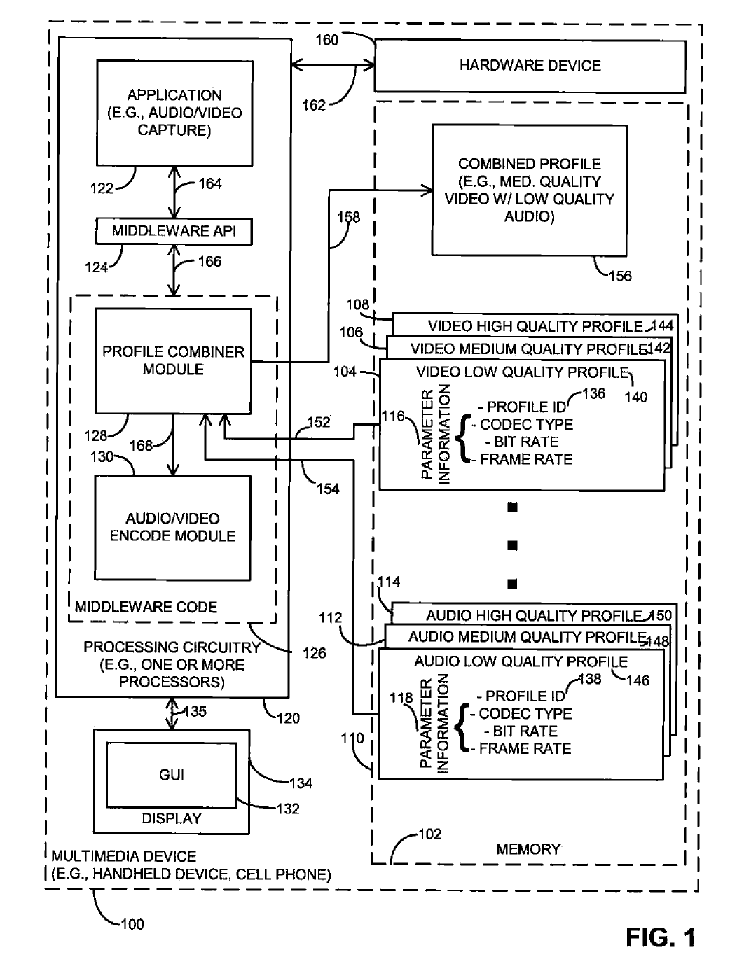

FIG. 1 shows one example of a multimedia device 100, such as a handheld device, a cell phone, a music player, a camera, a portable computer, a desktop computer, or another similar device. Multimedia device 100 contains memory 102 (i.e., a storage medium) having profiles 104, 106, 108, 110, 112, 114 that contain parameter information 116, 118. Note that profiles 106, 108, 112, and 114 also contain parameter information, although it is not shown in FIG. 1. Memory 102 may be any type of memory conventionally known in the art, such as random access memory (RAM), read-only memory (ROM), programmable memory (PROM), erasable PROMs (EPROM), electrically erasable PROM (EEPROM), flash memory, magnetic storage devices (e.g., hard disks, floppy disks, magnetic tape), optical disc drives, or any other suitable non-volatile memory now known or later developed.

In addition to profiles 104-114, memory 102 also contains computer readable instructions that processing circuitry 120 may execute. Processing circuitry 120 may include one or more central processing units (CPUs), distributed processing circuitry, application specific integrate circuits (ASICs), state machines, discrete logic, or any other suitable processing circuitry known in the art. In multimedia device 100, processing circuitry 120, among other things, executes computer readable code stored in memory such as application 122, middleware API 124, and middleware code 126. Middleware code 126 includes a profile combiner module 128 and an audio/video encode module 130. Processing circuitry is also operatively connected to display 132, which may display, among other things, graphical user interface (GUI) 134.

Profiles 104-114 are groups of data that represent groups of parameters. Profiles contain parameter information, such as 116, 118. Parameter information 116, 118, consists of any information that may relate to various settings of a hardware device, such as resolutions, compression options, display positions, display devices. Other examples of parameter information include, but are not limited to, encoding modes, frame size, and overlay position. For example, profile 104 contains parameter information 116 that corresponds to a hardware device that may capture video. Thus, relevant parameter information may include, for example, codec type, bit rate (including, for example, maximum and minimum), frame rate, sample rate, number of channels, stream format, channel mode, frame format, DTX mode, advance audio coding (“AAC”) profile, AAC tools, adaptive multi-rate (“AMR”) band mode and other related attributes, noise suppression information, CDMA rate, number of voices, loop mode, bits per sample, volume information (e.g., left, right, etc.), resolution, white balance, camera parameters, display parameters, or any other suitable parameter information.

In one example, profile 118 contains parameter information 118 for audio playback, and therefore may have parameter information relating to, among other things, the codec type and bit rate. It is further noted that memory 102 contains a set of profiles for a common device function. For example, profiles 104, 106, and 108 form a set of profiles related to video capture. Profiles 110, 112, and 114 form a set of profiles related to audio capture.

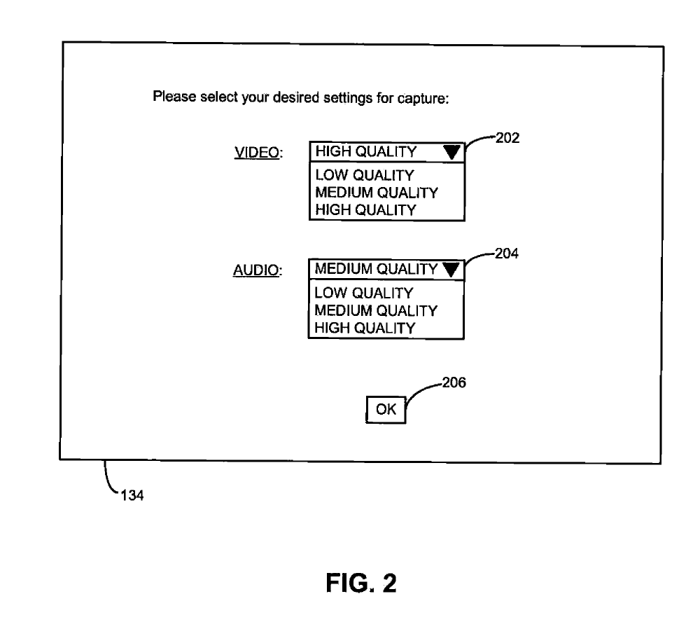

Each profile corresponds to device graphical user interface options, in one example. As noted throughout, each profile may correspond, for example, to an embedded device manufacturer's specifications for a given use case with or without a graphical user interface. As shown in FIG. 2, for example, GUI 134 is shown asking for user input. Processing circuitry 120 passes GUI information 135 to display 132 to display as GUI 134. Display 132 may also pass GUI information 135, such as user input, back to processing circuitry 120. In this example, a user is being asked to select, from a drop down box, different graphical user interface options. For example, a user may use drop down box 202 to select a device graphical user interface option relating to video. In this example, a user may select “Low Quality,” which corresponds to profile 104, “Medium Quality,” which corresponds to profile 106, or “High Quality,” which corresponds to profile 108. A user may use drop down box 204 to select a device graphical user interface option relating to audio. In this example, a user may select “Low Quality,” which corresponds to profile 110, “Medium Quality,” which corresponds to profile 112, or “High Quality,” which corresponds to profile 110. It is understood that the device graphical user interface options may be presented in any suitable manner, such as the drop down boxes as shown, radio buttons, check boxes, text input, or any other suitable method known in the art. Once a user selects the device user interface options, the user may press the OK button 206 to return the selections as GUI information 135 to processing circuitry 120.

It is understood that the labels, for example “Low Quality,” may be created by code in an application 122 or may be stored in memory 102 as part of the profile. It is also understood, for example, that each profile may contain a profile reference. The profile reference may be, for example, a profile ID 136, 138, a profile label 140-150, or any other suitable profile reference. A profile ID 136, 138, for example, may be an integer. A profile label 140-150 may be a string of text that may be presented to a user in a GUI 134 and implicitly conveys some information about the profile. For example, “Video Low Quality Profile” conveys that the profile is for video and is for “low quality.” It is understood that “low quality” is relative to a particular piece of hardware, e.g., one piece of hardware's low quality may be a higher quality than another piece of hardware's high quality. As described above, this is because different hardware devices have different capabilities.

Processing circuitry 120 is operative to use parameter information, such as parameter information 116, 118, in response to executing stored computer readable instructions that reference the profiles 104-114. For example, profile data 152, 154 goes from memory 102 to processing circuitry 120. As shown in the example in FIG. 1, middleware code 126 contains a profile combiner module 128, which is operative to create a combined profile 156 containing parameter information from at least one profile. In a preferred embodiment, however, combined profile 156 contains parameter information from more than one profile. In the particular example shown in FIG. 1, profile combiner module 128 receives profile data 152 and profile data 154. Profile data 152 is associated with a user's selection from drop down box 202 and is related to video hardware; profile data 154 is associated with a user's selection from drop down box 204 and is related to audio hardware. Profile combiner module 128 combines profile data 152, 154 and sends combined profile data 158 to memory 102, stored as combined profile 156. Although this example includes combining profile data associated with a video hardware device and an audio hardware device, it is contemplated that the combined profiles may be associated with any suitable hardware devices. Furthermore, a combined profile may contain parameter information for only one hardware device. For example, FIG. 1 shows one containing codec type, bit rate, and frame rate (for video), but it is contemplated that one profile may be used for a video codec type while another video profile is used for video bit rate. These two profiles may then be combined and stored in memory as a combined profile. Additionally, a combined profile receives a new profile reference, such as a new profile ID. Combined profiles are discussed in more detail below.

To better understand the multimedia device 100 shown in FIG. 1, a method for controlling hardware on a device will now be described. It is understood that although references will be made to FIG. 1 and the device 100, any suitable device may be used to implement the below-described method.

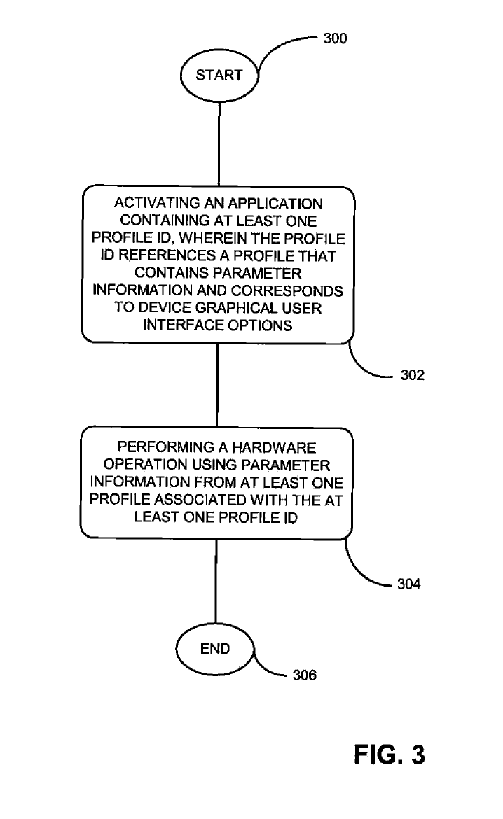

As shown in FIG. 3, the method starts in block 300. As shown in block 302, the method includes activating an application 122 containing at least one profile reference, such as profile ID 136 or 138. As discussed above, the profile reference 136, 138 references a profile such as 104, 110 that contains parameter information 116, 118 and corresponds to device graphical user interface options 202, 204. This is not a one-to-one correspondence. As one good example, parameter information may correspond to the graphical user interface, but it may also correspond to an embedded device manufacturer's specifications for a given use case (even without a direct graphical user interface). Next, as shown in block 304, the method may include performing a hardware operation using parameter information from at least one profile associated with the at least one profile reference, such as profile ID 116, 118. The hardware operation may be associated with hardware device 160. Note, however, that display 132 could also be a hardware device on which the hardware operation is performed. For example, processing circuitry 120 may send and receive hardware device operation data 162 to and from hardware device 160. Examples of hardware operations are discussed above. The method then ends in block 306.

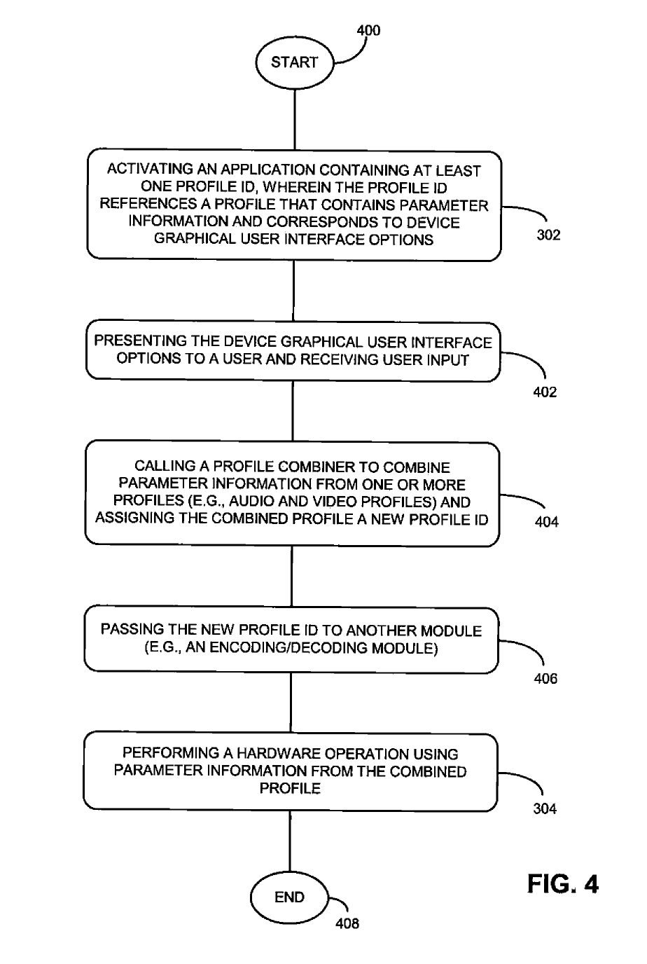

The method, however, may include any other suitable steps, either before, after, or between the above-described steps. For example, a method shown in FIG. 4 starts at block 400 and contains the same steps 302 and 304 as described in relation to FIG. 3. This method, however, also includes the steps shown in blocks 402, 404, and 406. As shown in block 402, the method may include presenting the device graphical user interface options 202, 204 to a user and receiving user input.

Application 122 sends application data 164 to and from middleware API (application programming interface) 124. Middleware API 124 is an interface between middleware code 126 and application 122. Middleware API supports a limited number of functions that allow an application 122 to make use of the middleware code 126 to use profiles, such as profiles 104-114. Middleware API data 166 is then sent to and from middleware API 124 and middleware code 126.

Middleware code 126 may include a profile combiner module 128, and as shown in block 404, the method may include calling the profile combiner module 128 to combine parameter information (e.g., 116, 118) from one or more profiles (e.g., 104-114) and assigning the combined profile a new profile reference, such as a new profile ID. Although the combined profile may correspond to device graphical user interface options, it is also understood that the combined profile may correspond to design decisions. For example, the design decision can be fixed initially, but since the parameters are in a profile, the parameters can be easily chanted. It is further understood that a manufacturer may choose a profile depending on the contextual use of the device. In one example, application 122 may pass middleware API 124 profile IDs 136 and 138. It is understood however, that any other suitable profile reference may be used. Middleware API 124 then passes the profile IDs 136, 138 to the profile combiner module 128 (part of middleware code 126). Profile combiner module 128 then retrieves parameter information 116, 118 from memory 102.

In building a combined profile 156, profile combiner module 128 creates a new combined profile that contains parameter information 116, 118 from all combined profiles. It is possible, for example, that some profiles may contain conflicting parameter information. For example, a first profile may set a bit rate for video encoding, and the first profile may be combined with a second profile that has parameter information setting a different bit rate for the video encoding. In such cases, any suitable conflict-resolving method may be implemented. For example, if parameter information is already set, the profile combiner module 128 may ignore any conflicting parameter information in other profiles. Alternatively, the profile combiner module 128 may override any parameter information that exists in a combined profile 156.

Next, as shown in block 406, the method may include passing the new profile reference, such as a new profile ID, to another module. For example, profile combiner module 128 may pass combined profile reference data 168 to an audio/video encode (or decode) module 130. The audio/video encode module 130 may then use the new profile reference to use the combined profile to perform a hardware operation using the parameter information from the combined profile, as shown in block 304. The method ends in block 408.

The method may fisher include, for example, presenting, to a user, the device graphical user interface options 202, 204 that correspond to the profile reference referencing the profile that contains parameter information. The received input may then be used to perform the correct hardware operation. Furthermore, the method may include receiving additional user input, passing at least one additional profile reference, based on the additional user input, to the encoder to perform at least one additional hardware operation. For example, a user may choose graphical user interface options corresponding to profiles with parameter information that causes a hardware device 160, e.g., a display, to display multimedia content (e.g., an image, video, etc.) in the upper-right portion of the screen. A user may then provide additional user input, perhaps with a mouse or a keystroke or combination thereof, that causes the application 122 to pass at least one additional profile reference to the middleware API 124, which in turn passes the additional profile reference to middleware code 126. The audio/video encode module 130 may then change the positioning of the image or video on the display. For example, the position may change to the lower-left corner of the display, or the multimedia may be displayed full screen.

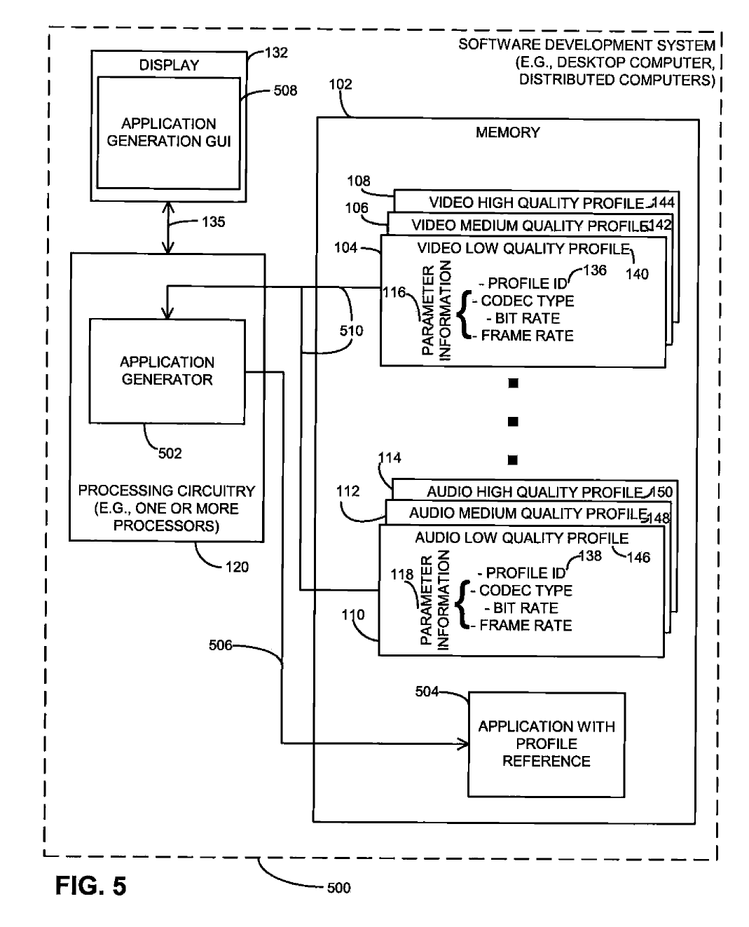

Turning now to FIG. 5, a software development system 500 is shown, which may include, for example, a desktop computer, a notebook computer, a network of computer systems, or any other suitable development system. The system, for example, may be distributed over one or more local or remote systems as known in the art. The software development system 500 may include, for example, a display 132, processing circuitry 120, and memory 102.

As shown, memory 102 may contain profiles, such as profiles 104-114. This, however, is not required. Profiles 104-114 are similar to the profiles discussed above. In one example, the manufacturer of a hardware device 160 may create these profiles. Since the hardware device 160 manufacturer is in the best position to know the specifications and capabilities of the hardware device 160, this may be preferred. Alternatively, a knowledgeable programmer may assist a manufacturer in creating the profiles. It is understood, however, that any suitable programmer may create the profiles 104-114. Furthermore, the profiles may be created on software development system 500, although it is understood that any other suitable environment may be used.

The memory 102 may contain computer readable instructions executable by processing circuitry 120. Processing circuitry 120 may execute the computer readable instructions, shown as application generator 502. Application generator 502 may generate data representing an application 504 containing a profile reference (such as profile ID 136 or 138) that identifies a profile (such as profile 104, 110) having parameter information (such as 116, 118) that corresponds to device graphical user interface options (such as 202, 204). Application generator 502 may send application data 506 to store it in memory as shown. As described above, memory may be distributed or on the software development system 500. In one example, application generator 502 could store the application 504 to a hard drive on the software development system 500. In another example, application generator 502 could store application 504 on a multimedia device 100.

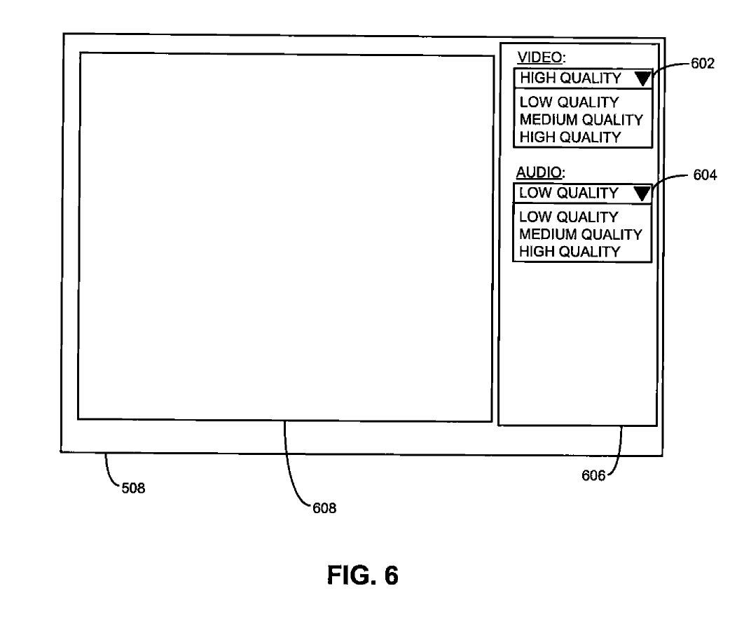

Application generator 502 may also provide an application generation graphical user interface (GUI) 508 that is viewable on display 132 by sending GUI information 135 to display 132. As shown in more detail in FIG. 6, the application generation GUI 508 may provide profile reference insertion options 602, 604, located within sidebar 606, that correspond to a profile reference that identifies a profile having parameter information that corresponds to device graphical user interface options. Application generation GUI 508 may also contain programming window 608 in which a programmer may insert programming code to program an application 504. Thus, in operation, a programmer may use programming window 608 to write code as known in the art, but may also use the profile reference insertion options 602, 604 to insert profile references, such as profile ID 136 or 138, into application 504.

In operation of one example, a programmer may be developing an application 504 to capture video from a hardware device 160. In prior art solutions, a programmer would have to code hundreds of lines that define different qualities of video and audio for each particular hardware device 160. By inserting profile references into application 504, however, a programmer may only need to know the profile reference needed that corresponds to a profile having the parameter information that the programmer would otherwise need to know. The programmer may directly type a profile reference (such as a profile ID, a profile label, etc.) into programming window 608.

Alternatively, a first programmer that is not the application 504 developer may set up a definition file defining a constant, e.g., a label, for each profile. When an application developer then develops application 504, he may use the constant in programming window 608, thereby referencing the desired profile.

In yet another example, application generator 502 may receive profile data 510 from memory 102, use it to generate profile reference insertion options 602, 604, send it to display 132 as GUI information 135, and then provide the profile reference insertion options 602, 604 on application generation GUI 508. Similar to graphical user interface options 202, 204, profile reference insertion options 602 604 may be in any suitable format. For example, they may appear in drop down boxes as shown, check boxes, radio buttons, or via any other suitable presentation method. In one example, when a user selects a profile reference insertion option 602 or 604, the corresponding profile reference is inserted into programming window 608.

Among other advantages, software developers may more quickly and more efficiently develop software applications that interact with hardware devices. Furthermore, software developers do not have to spend valuable time typing large amounts of code to correspond to the specific capabilities or parameters of a given hardware device.

The above detailed description of the invention and the examples described therein have been presented for the purposes of illustration and description only and not by limitation. It is therefore contemplated that the present invention cover any and all modifications, variations or equivalents that fall within the spirit and scope of the basic underlying principles disclosed above and claimed herein.

What is claimed is:

1. A device comprising:
memory comprising profiles that contain parameter information, wherein the profiles correspond to device programmable options, which correspond to options presented through a graphical user interface; and
processing circuitry operative to use the parameter information in response to executing stored computer readable instructions that reference the profiles.

2. The device of claim 1 wherein the parameter information is associated with a hardware operation of the device.

3. The device of claim 2 wherein the parameter information is associated with at least one of: a bit rate, a codec type, and a frame rate.

4. The device of claim 1 wherein the processing circuitry is operative to create a combined profile containing parameter information from at least one profile.

5. The device of claim 4 wherein the combined profile contains parameter information for at least video hardware and audio hardware.

6. The device of claim 1 wherein the memory comprises a set of profiles for a common device function.

7. A hand held device comprising:
processing circuitry operative to execute stored computer readable instructions;
memory comprising stored computer readable instructions that contain references to at least one profile reference that corresponds to a profile having parameter information that corresponds to device graphical user interface options;
memory comprising stored computer readable instructions operative as middleware that when executed cause the processing circuitry to uses the at least one profile reference to retrieve the parameter information and control device hardware operations using the parameter information; and
memory containing the parameter information indexed by the profile reference.

8. The hand held device of claim 7 wherein the parameter information is associated with at least one of a bit rate, a codec type, and a frame rate.

9. The device of claim 7 further comprising:
a profile combiner module operative to create a combined profile containing parameter information from at least one profile.

10. The hand held device of claim 9 wherein the combined profile contains parameter information for at least video hardware and audio hardware.

11. A method for controlling hardware on a handheld device comprising:
activating an application containing at least one profile reference, wherein the profile reference references a profile that contains parameter information and corresponds to device graphical user interface options; and
performing a hardware operation using parameter information from at least one profile associated with the at least one profile reference.

12. The method of claim 11 further comprising:
calling a profile combiner module; and
combining parameter information from more than one profile to build a combined profile that corresponds to device graphical user interface operations.

13. The method of claim 12 further comprising assigning the combined profile a new profile reference.

14. The method of claim 11 further comprising:
presenting, to a user, the device graphical user interface options that correspond to the profile reference referencing the profile that contains parameter information; and
receiving user input.

15. The method of claim 14 further comprising:
receiving additional user input; and
passing at least one additional profile reference, based on the additional user input, to an encoder to perform at least one additional hardware operation.

16. The method of claim 11 wherein the hardware operation comprises at least one of: audio coding, video coding, and image coding.

17. A software development system comprising:
processing circuitry operative to execute computer readable instructions comprising an application generator to generate data, representing an application, from source code containing a profile reference that identifies a profile having parameter information that corresponds to device graphical user interface options; and
a memory containing the computer readable instructions and the application containing a profile reference that identifies a profile having parameter information that corresponds to device graphical user interface options.

18. The software development system of claim 17 wherein the application generator is further operative to provide an application generation graphical user interface viewable on the display and operative to provide profile reference insertion options that correspond to a profile reference that identifies a profile having parameter information that corresponds to device graphical user interface options.

19. The software development system of claim 17 wherein the parameter information is associated with a hardware operation.

20. The software development system of claim 19 wherein the parameter information is associated with at least one of: a bit rate, a codec type, and a frame rate.

21. The software development system of claim 19 wherein the parameter information is associated with at least one of: video hardware and audio hardware.

22. A storage medium containing stored computer readable instructions executable by one or more processing devices that, when executed by the one or more processing devices, cause the one or more processing devices to:
generate data, representing an application, from source code containing a profile reference that identifies a profile having parameter information that corresponds to device graphical user interface options.

23. The storage medium of claim 22 wherein the computer readable instructions, that when executed by the one or more processing devices, further cause the one or more processing devices to:
provide an application generation graphical user interface viewable on a display and operative to provide profile reference insertion options that correspond to a profile reference that identifies a profile having parameter information that corresponds to device graphical user interface options.

24. The storage medium of claim 22 wherein the parameter information is associated with a hardware operation.

25. The storage medium of claim 24 wherein the parameter information is associated with at least one of: video hardware and audio hardware.
